(19) United States
(12) Patent Application Publication
(10) Pub. No.: US 2020/0250630 A1
(43) Pub. Date: Aug. 6, 2020

(54) METHOD, DEVICE, ELECTRIC APPARATUS AND TERMINAL APPARATUS FOR CONFIRMING ORDER DELIVERY

(71) Applicants: Beijing Jingdong Shangke Information Technology Co., Ltd., Beijing (CN); Beijing Jingdong Century Trading Co., Ltd., Beijing (CN)

(72) Inventors: Hongye Zhao, Beijing (CN); Yanchao Miao, Beijing (CN)

(21) Appl. No.: 16/636,093

(22) PCT Filed: Apr. 4, 2018
(86) PCT No.: PCT/CN2018/081958

§ 371 Date: Feb. 3, 2020

(30) Foreign Application Priority Data
Sep. 8, 2017 (CN) 201710806129.5

(51) Int. Cl. G06Q 20/04; G06Q 20/32; G06Q 20/38; G06Q 10/08

(52) U.S. Cl. CPC G06Q 20/0453; G06Q 20/3276; G06Q 2220/00; G06Q 10/0833; G06Q 20/3825

(57) ABSTRACT

A method and an apparatus for signing a receipt of an order are provided. The method includes receiving payment request information sent by a user terminal, the payment request information including identifier information of the user terminal, code information corresponding to the order, and payment account information, the payment request information being generated by the user terminal through scanning a payment QR code corresponding to the order on a delivery terminal; determining whether a to-be-paid amount corresponding to the order is greater than zero; returning, in response to determining that the to-be-paid amount corresponding to the order is greater than zero, a payment page corresponding to the order to the user terminal; and pushing, in response to receiving information of a successful payment of the to-be-paid amount from the user terminal, a customer receipt signing page corresponding to the order to the user terminal.

### CROSS-REFERENCE TO RELATED APPLICATIONS

This application claims priority to Chinese Patent Application No. 201710806129.5, filed on Sep. 8, 2017, titled “Method, Apparatus, Electronic Device and Terminal Device for Signing Receipt of Order,” which is hereby incorporated by reference in its entirety.

### TECHNICAL FIELD

The present disclosure relates to the field of computer technology, specifically to the field of e-commerce technology, and more specifically to a method, apparatus, electronic device, and terminal device for signing a receipt of an order.

### BACKGROUND

In the logistics industry, signing a receipt of an order is the last step of order delivery, and completing the signature of the receipt of the order means that goods involved in the order are successfully delivered to a user. With the development of e-commerce technology, electronic signature receipts for orders have gradually replaced paper customer signature receipts. Once a customer's name is signed on a customer signature receipt, it may be regarded as that items corresponding to the order have been successfully delivered.

At present, a deliveryman triggers a delivery terminal to acquire the electronic signature receipt from a server, and the electronic signature receipt is finally presented on the delivery terminal of the deliveryman. A signer of an order receipt may sign his name on the electronic signature receipt to complete signature of the order receipt. The signature here refers to signing on the electronic signature receipt by operating a delivery terminal screen through touch.

Generally, only after a successful payment by the user, can the above electronic signature receipt be acquired. If a customer performs the payment when the deliveryman delivers items involved in the order, the receipt signer first needs to pay, and then can sign his name on the delivery terminal of the deliveryman to complete signature of the order receipt. With the development of e-commerce, scan payment is more and more popular. The receipt signer may pay by scanning a payment QR code presented on the deliveryman terminal. After the receipt signer successfully performs the scan payment, the deliveryman acquires the electronic customer signature receipt of the order through the delivery terminal, and the customer can sign his name on the electronic customer signature receipt.

After the receipt signer successfully performs scan payment, a process in which the deliveryman acquires an electronic page of the signature receipt from the server, to allow the customer to sign the receipt, mainly has the following problems: First, the scan payment and the receipt signing of the customer are completely separated, and the operations are cumbersome and time-consuming. Second, the electronic signature is completed at the terminal of the deliveryman. If the deliveryman omits this process during delivery to save time, then the deliveryman collectively signs receipts after completing delivering all orders, a phenomenon that the deliveryman signs instead after properly delivering the goods occurs. If once the user has a dispute about the above order signed by the deliveryman, significant economic losses will be brought to the company.

### SUMMARY

An object of embodiments of the present disclosure is to provide a method, apparatus, electronic device, and terminal device for signing a receipt of an order, to solve the technical problems mentioned in the background section.

In a first aspect of the present disclosure, a method for signing a receipt of an order is provided. The method includes receiving payment request information sent by a user terminal, the payment request information comprising identifier information of the user terminal, code information corresponding to the order, and payment account information, the payment request information being generated by the user terminal through scanning a payment QR code corresponding to the order on a delivery terminal; determining whether a to-be-paid amount corresponding to the order is greater than zero; returning, in response to determining that the to-be-paid amount corresponding to the order is greater than zero, a payment page corresponding to the order to the user terminal; and pushing, in response to receiving information of a successful payment of the to-be-paid amount from the user terminal, a customer receipt signing page corresponding to the order to the user terminal.

In a second aspect of the present disclosure, a method for signing a receipt of an order is provided. The method includes scanning a payment OR code corresponding to a to-be-signed order on a delivery terminal, the payment QR comprising code information of the order and information of a beneficiary account; receiving a payment page corresponding to the order and being returned based on a scan of the payment QR code and a to-be-paid amount, the to-be-paid amount corresponding to the order and being greater than zero; paying, in response to a user operation, the to-be-paid amount to the beneficiary account; and receiving a customer receipt signing page corresponding to the order and being returned based on a successful payment to the beneficiary account, the customer receipt signing page comprising code information of the order, receipt signing time information, and an area for signature.

In a third aspect of the present disclosure, an apparatus for signing a receipt of an order is provided. The apparatus includes a payment request information receiving unit configured to receive request information sent by a user terminal, the request information comprising identifier information of the user terminal, order code information corresponding to the order, and payment account information, the request information being generated by the user terminal through scanning a payment QR code corresponding to the order on a delivery terminal; a determining unit configured to determine whether a to-be-paid amount corresponding to the order is greater than zero; a payment page returning unit configured to return, in response to determining that the to-be-paid amount corresponding to the order is greater than zero, a payment page corresponding to the order to the user terminal; and a pushing unit configured to push, in response to receiving information of a successful payment of the to-be-paid amount from the user terminal, a customer receipt signing page corresponding to the order to the user terminal.

In a fourth aspect of the present disclosure, an apparatus for signing a receipt of an order is provided. The apparatus includes a scanning unit configured to scan a payment QR code corresponding to the order on a delivery terminal, the payment QR code comprising code information of the order and information of a beneficiary account; a payment page receiving unit configured to receive a payment page corresponding to the order, the received payment page being returned based on a scan of the payment QR code and a to-be-paid amount corresponding to the order being greater than zero; a paying unit configured to pay in response to a user operation, the to-be-paid amount to the beneficiary account; and a signing page receiving unit configured to receive a customer receipt signing page corresponding to the order and being returned based on a successful payment to the beneficiary account, the customer receipt signing page comprising code information of the order, receipt signing time information, and an area for signature.

In a fifth aspect of the present disclosure, an electronic device is provided, including one or more processors; and a storage apparatus for storing one or more programs, where the one or more programs, when executed by the one or more processors, cause the one or more processors to implement the method for signing a receipt of an order.

In a six aspect of the present disclosure, a terminal device is provided, including one or more processors; and a storage apparatus for storing one or more programs, where the one or more programs, when executed by the one or more processors, cause the one or more processors to implement the method for signing a receipt of an order.

The method, apparatus, electronic device, and terminal device for signing a receipt of an order provided by some embodiments of the present disclosure receive payment request information sent by a user terminal, then determine whether a to-be-paid amount corresponding to the order is greater than zero, then return, in response to determining that the to-be-paid amount corresponding to the order is greater than zero, a payment page corresponding to the order to the user terminal; and finally push, in response to receiving information of successfully paying the to-be-paid amount from the user terminal, a customer receipt signing page corresponding to the order to the user terminal. The method for signing a receipt of an order provided by some embodiments of the present disclosure may present, after scan payment by a user terminal, a customer receipt signing page corresponding to the order on the user terminal, to facilitate signing a receipt by a user, simplify the process of payment and signing a receipt, to shorten the time for payment and signing a receipt, and further avoid the behavior of substitutive signing by a deliveryman.

In some embodiments, the above method further includes, after the pushing a customer receipt signing page corresponding to the order to the user terminal, receiving and storing receipt signing scenario information that is collected, encrypted, and uploaded by the user terminal, to further avoid the behavior of substitutive signing by the deliveryman.

### BRIEF DESCRIPTION OF THE DRAWINGS

After reading detailed description of non-limiting embodiments with reference to the following accompanying drawings, other features, objectives and advantages of the present disclosure will become more apparent.

FIG. 1 is a diagram of an example system architecture in which embodiments of the present disclosure may be implemented;

FIG. 2 is a flowchart of a method for signing a receipt of an order according to an embodiment of the present disclosure;

FIG. 3 is a schematic diagram of a process of a method for signing a receipt of an order according to another embodiment of the disclosure;

FIG. 4 is a schematic structural diagram of an apparatus for signing a receipt of an order according to an embodiment of the present disclosure;

FIG. 5 is a schematic structural diagram of an apparatus for signing a receipt of an order according to another embodiment of the present disclosure; and

FIG. 6 is a schematic structural diagram of a computer system adapted to implement a terminal device or electronic device of the embodiments of the present disclosure.

### DETAILED DESCRIPTION OF EMBODIMENTS

The present disclosure will be further described in detail below in combination with the accompanying drawings and the embodiments. It may be understood that the specific embodiments described herein are merely used for explaining the relevant disclosure, rather than limiting the disclosure. In addition, it should be further noted that, for the ease of description, only the parts related to the relevant disclosure are shown in the accompanying drawings.

It should be noted that some embodiments in the present disclosure and some features in the embodiments may be combined with each other on a non-conflict basis. The present disclosure will be described in detail below with reference to the accompanying drawings and in combination with the embodiments.

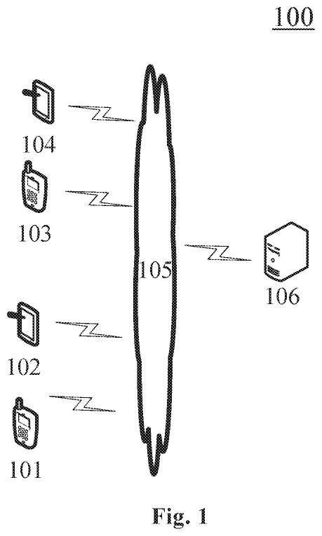

FIG. 1 shows an example system architecture 100 in which a method for signing a receipt of an order or an apparatus for signing a receipt of an order of embodiments of the present disclosure may be implemented.

As shown in FIG. 1, the system architecture 100 may include user terminal devices 101 and 102, delivery terminal devices 103 and 104, a network 105, and a server 106 providing support for the user terminal devices 101 and 102, and the delivery terminal devices 103 and 104.

A user may interact with the server 106 using the user terminal devices 101 and 102 via the network 105, to receive or send a message. The user terminal devices 101 and 102 may be provided with various communication client applications, such as a web browser application, a shopping application, a search application, and an instant messaging tool. A QR code scanning function may embedded within the shopping application.

A deliveryman may interact with the server 106 using the delivery terminal devices 103 and 104 via the network 105, to receive or send a message. For example, the delivery terminal devices 103 and 104 may receive relevant information of a delivery order sent by the server 106 via the network 105, where the relevant information of the delivery order may include code information of the order and an order-related payment QR code. The user terminal devices 101 and 102 may open a payment window by scanning the order-related payment QR code displayed on the delivery terminal devices 103 and 104. Further, the user terminal device may pay for the above order through the payment window and a back-end payment system. The back-end payment system returns successful payment information to the server 106.

The user terminal devices 101 and 102, and the delivery terminal devices 103 and 104 may be various electronic devices having a display screen and supporting a goods delivery service, including but not limited to a smart phone, a tablet computer, an e-book reader, an MP3 (Moving Picture Experts Group Audio Layer III) player, an MP4 (Moving Picture Experts Group Audio Layer IV) player, a laptop portable computer, a desktop computer, or the like.

The server 106 may be a server providing various services, such as a back-end order processing server providing support for a logistics application on the user terminal devices 101 and 102. The above back-end order processing server may send the order-related payment QR code to the delivery terminal devices 103 and 104, and push a customer receipt signing page to the user terminal devices 101 and 102 after receiving information of successful payment on the above order.

It should be understood that the numbers of user terminal devices, delivery terminal devices, networks, and servers in FIG. 1 are merely illustrative. Any number of user terminal devices, delivery terminal devices, and servers may be provided based on actual requirements.

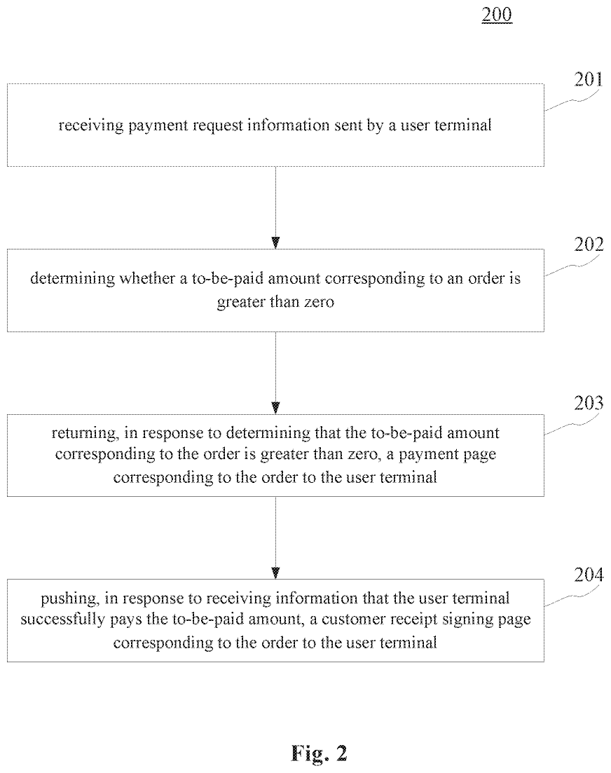

Further referring to FIG. 2, a process 200 of a method for signing a receipt of an order according to an embodiment of the present disclosure is shown. It should be noted that the method for signing a receipt of an order provided by the present embodiment is generally executed by the server 105. Accordingly, the apparatus for signing a receipt of an order is generally provided in the server 105.

As shown in FIG. 2, the method for signing a receipt of an order includes the following steps:

Step 201: receiving payment request information sent by a user terminal.

In the present embodiment, an electronic device (e.g., the server 106 shown in FIG. 1) on which the method for signing a receipt of an order is run may first receive a request for acquiring a payment QR code of an order in a stage for payment and receipt signing sent by a delivery terminal (e.g., the delivery terminal device 103 or 104 shown in FIG. 1) through wired connection or wireless connection. After receiving the request for acquiring the payment QR code, the electronic device may send the payment QR code corresponding to the order to the delivery terminal based on code information of the order.

The user terminal (e.g., the user terminal devices 101 and 102 shown in FIG. 1) may scan the payment QR code corresponding to the order presented on a delivery terminal screen, thereby sending the payment request information to the electronic device.

The electronic device may receive the payment request information from the user terminal through wired connection or wireless connection. The payment request information may be generated by the user terminal through scanning the payment QR code corresponding to the order on the delivery terminal. The payment request information may include identifier information of the user terminal, the code information of the order, and payment account information.

Here, the identifier information of the user terminal may include an International Mobile Subscriber Identification Number (IMSI).

Step 202: determining whether a to-be-paid amount corresponding to an order is greater than zero.

In the present embodiment, the electronic device itself on which the method for signing a receipt of an order is run may be configured to store information of a plurality of orders, where the information of the above order may include the code information of the order and information of the to-be-paid amount of the order. That is, the electronic device itself may be a database storing order information. In addition, the electronic device and a database storing the information of the plurality of orders may also be connected to each other, such that the electronic device acquires information of the orders from the database.

After receiving the payment request information sent by the user terminal, the electronic device may confirm the received Payment request information. Specifically, the code information of the order may be confirmed, and to-be-paid amount information corresponding to the order may be confirmed.

The electronic device may determine whether the to amount corresponding to the order is greater than zero in a local database based on the code information of the order. In addition, the electronic device may further acquire the information of the order from the database connected to the electronic device based on the code information of the order, and determine whether the to-be-paid amount corresponding to the order is greater than zero.

In some application scenarios, a payment mode of the order placed by a user is cash on delivery. In the case of this payment mode, the to-be-paid amount corresponding to the order stored in the database is greater than zero.

Step 203: returning, in response to determining that the to-be-paid amount corresponding to the order is greater than zero, a payment page corresponding to the order to the user terminal.

In response to determining that the to-be-paid amount corresponding to the order is greater than zero, the electronic device may open an interface for payment settlement with a financial institution, for the user terminal, and then return the payment page corresponding to the order to the user terminal.

The payment page presented on the user terminal screen may include the above to-be-paid amount, as well as payment financial institutions for selection by the user.

The user may pay for the above order by the payment page and a back-end payment system. If the payment is successful, then the back-end system may feed back successful payment information to the electronic device, and may also send successful money deduction information to the user terminal.

Step 204: pushing, in response to receiving information that the user terminal successfully pays the to-be-paid amount, a customer receipt signing page corresponding to the order to the user terminal.

In step 203, after receiving the successful payment information corresponding to the above order, the electronic device may push the customer receipt signing page corresponding to the above order to the user terminal.

The user can sign his name on the customer receipt signing page by a touch operation on a display screen of the user terminal.

In the present embodiment, after scan payment by the user terminal device, the electronic device may push the receipt signing page to the user terminal device. Thus, after successful payment on the user terminal device, the user may directly electronically sign the receipt on the receipt signing page displayed on a screen of the user terminal device, which can not only facilitate simplifying the operations, and saving the delivery time; but also contribute to limiting the behavior of collective and substitutive signature by a deliveryman after delivery.

In some application scenarios, a payment mode selected by the user when placing the order is online payment. That is, the to-be-paid amount is paid online shortly after the order is generated. Thus, the to-be-paid amount corresponding to the order stored in the database of the electronic device or the database connected to the electronic device is zero. After scanning the payment QR code on the delivery terminal by the user terminal, the electronic device determines the to-be-paid amount corresponding to the order being equal to zero, and pushes the customer receipt signing page corresponding to the order to the user terminal. The user signs the receipt on the user terminal. Thus, a receipt signer may sign his name on the user terminal to complete signing the receipt of the order.

In some other application scenarios, the user may choose cash payment when the deliveryman is delivering goods involved in the order. In this case, information of completing payment by the user may be submitted to the electronic device via the delivery terminal, and the electronic device modifies the to-be-paid amount corresponding to the order in the database to zero. Then, the user terminal scans the payment QR code on the delivery terminal for signing a receipt.

In some alternative implementations of the present embodiment, the above method for signing a receipt of an order may further include step 205: receiving and storing receipt signing scenario information that is collected, encrypted, and uploaded by the user terminal.

Here, after pushing a customer receipt signing page to the user terminal, the electronic device (the server 106 in FIG. 1) on which the method for signing a receipt of an order is run may send an instruction for collecting the receipt signing scenario information to the user terminal, such that the user terminal collects the receipt signing scenario information. The receipt signing scenario information may include face image information of the receipt signer, geographical location information of the user terminal, and identity information of the user terminal. Specifically, after receiving the instruction for collecting the receipt signing scenario information from the electronic device, the user terminal may initiate a camera arranged on the user terminal to collect the face image information of the receipt signer; may acquire the geographical location information of the user terminal by a GPS positioning system arranged in the user terminal; and may further acquire the identity information of the user terminal based on a preset instruction.

In some alternative implementations of the present embodiment, prior to collecting the above receipt signing scenario information by the user terminal, whether to agree to collecting the receipt signing scenario information may be prompted to the user by the user terminal. When the user agrees to collecting the above receipt signing scenario information, the collecting the above receipt signing scenario information may be continued.

After completing collecting the above scenario information, the user terminal may first encrypt the above scenario information, and then upload the encrypted receipt signing scenario information to the electronic device.

In some application scenarios, the electronic device may directly store the above encrypted receipt signing scenario information. When the user has a dispute about order delivery, the above encrypted receipt signing scenario information may be queried based on the code information of the order. Specifically, when the user queries the above receipt signing scenario information based an order code, the electronic device may first decrypt the encrypted receipt signing scenario information, and then send the decrypted receipt signing scenario information to the user terminal. The above receipt signing scenario information may be used as the basis for checking the order delivery, to avoid the dispute between the user and the delivery company to some extent. In addition, the encrypting the receipt signing scenario information helps to protect the user privacy.

Alternatively, the electronic device generates a receipt signing QR code corresponding to the encrypted receipt signing scenario information, and stores the above receipt signing QR code in the database. The generating the receipt signing QR code corresponding to the receipt signing scenario information can further help to prevent user information from being revealed.

Further, after the electronic device generates the receipt signing QR code corresponding to the encrypted receipt signing scenario information, when the user terminal queries the order based on an order code, the electronic device sends the receipt signing QR code to the user terminal, in response to receiving a query request from the user terminal, such that the user terminal scans the above receipt signing OR code, and then queries the receipt signing scenario information.

In some alternative implementations of the present embodiment, prior to collecting the above receipt signing scenario information by the user terminal, when the user does not agree to collecting the receipt signing scenario information, the identity information of the user terminal corresponding to the above order and being stored when placing the above order may be acquired from the database. A signature code is sent to the user terminal based on the identity information of the user terminal corresponding to the order and being stored in the database when placing the order, and the receipt signing page displayed on the user terminal of the receipt signer prompts the user to input the above signature code. Only after the receipt signer inputs a correct signature code into the above signing page, can the electronic device pass verification of the signature code. After passing the verification of the signature code, the electronic device may send prompt information to the user terminal to prompt the user to sign his name on the receipt signing page, thereby completing the signing a receipt of the order.

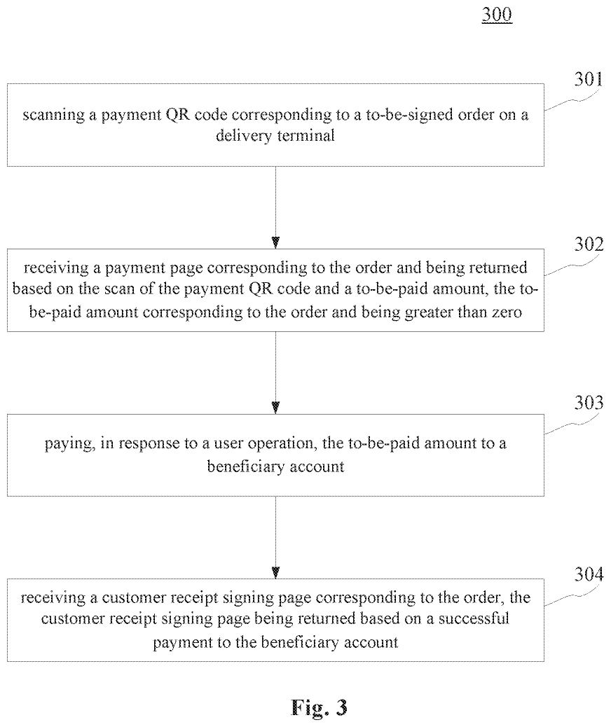

Further referring to FIG. 3, a process 300 of a method for signing receipt of an order according to another embodiment of the present disclosure is shown. It should be noted that the method for signing a receipt of an order provided by the present embodiment is generally executed by the user terminals 101 and 102. Accordingly, the apparatus for signing a receipt of an order is generally provided in the user terminals 101 and 102.

As shown in FIG. 3, the method for signing a receipt of an order includes the following steps:

Step 301: scanning a payment QR code corresponding to a to-be-signed order on a delivery terminal.

In the present embodiment, the payment QR code on the delivery terminal may be used as a carrier of order-related information. The above payment QR code may include code information of the to-be-signed order and information of a beneficiary account.

In the present embodiment, the del very terminal may acquire the above payment QR code corresponding to the to-be-signed order from a server (e.g. the server 106 shown FIG. 1) via a network. After the delivery terminal acquires the above payment QR code, a deliveryman may inform a receipt signer of scanning the above payment QR code using a terminal device. After scanning the above payment QR code, a terminal device (e.g., the user terminal 101 or 102 shown in FIG. 1) on which the method for signing a receipt of an order is run may establish communication connection with the above server.

Step 302: receiving a payment page corresponding to the order and being returned based on the scan of the payment QR code and a to-be-paid amount, the to-be-paid amount corresponding to the order and being greater than zero.

After the terminal device establishes the communication connection with the server by scanning, the above payment QR code in step 301, the server confirms the to-be-signed order and the to-be-paid amount corresponding to the above order based on the code information of the order. After determining the above to-be-paid, amount being greater than zero and confirming the information of the beneficiary account corresponding to the order being correct, the server opens an interface for settlement with a corresponding financial institution, and returns the payment page corresponding the above order to the terminal device. The terminal device receives the payment page corresponding to the above order and being returned based on the scan of the payment QR code and the to-be-paid amount, the to-be-paid amount corresponding to the order and being greater than zero. Alternatively, the above payment page may include a plurality of financial institutions to be selected by a user.

Step 303: paying, in response to a user operation, the to-be-paid amount to a beneficiary account.

In step 302, after the term anal device receives the payment page corresponding to the above order and being returned based on the scan of the above payment QR code and the to-be-paid amount, the to-be-paid amount corresponding to the above order and being greater than zero, the user may select a financial institution on the above payment page, and then perform a payment operation. Here, the payment operation may include inputting a payment amount, inputting a payment password, and the like. In response to the payment operation of the user, the terminal device pays the above to-be-paid amount to the beneficiary account by a back-end payment system. The description will not be repeated here.

Step 304: receiving a customer receipt signing page corresponding to the order, the customer receipt signing page being returned based on a successful payment to the beneficiary account.

In the present embodiment, the terminal device may receive the customer receipt signing page corresponding to the above order, the customer receipt signing page being returned by the server based on a successful payment to the beneficiary account.

The above customer receipt signing page may include the code information corresponding to the above order, signing time information, and an area for signature. The receipt signer may sign his name in the above area for signature.

In the present embodiment, the returned payment page may be received by scanning the payment QR code corresponding to the to-be-paid order on the delivery terminal, and then after the payment is performed for the above order through the payment page, a receipt signing page may be received for signing by the signer. Thus, both the payment page and the receipt signing page can be presented on the terminal device, thereby facilitating the user operation whilst improving the delivery efficiency.

In some alternative implementations of the present embodiment, a payment mode used by the user when placing the above order may be online payment, such that the to-be-paid amount corresponding to the above order is equal to zero. Thus, when the terminal device scans the payment QR code on the delivery terminal, the server may obtain the to-be-paid amount corresponding to the order being equal to zero by querying a code of the above order. Thus, the server may send the customer receipt signing page corresponding to the order to the above terminal device. That is, the terminal device may receive the customer receipt signing page corresponding to the above order and being returned based on the scan of the payment QR code and the to-be-paid amount, the to-be-paid amount corresponding to the order and being equal to zero.

In some alternative implementations of the present embodiment, the above method for signing a receipt of an order may further include step 305: collecting receipt signing scenario information, encrypting the collected receipt signing scenario information, and then uploading the encrypted receipt signing scenario information to a server corresponding to the beneficiary account. Here, the server corresponding to the beneficiary account may be the server 106 shown in FIG. 1. The receipt signing scenario information includes face information of a receipt signer, geographical location information of a user terminal, and identity information of the user terminal. As an example, the identity information of the user terminal may be an International Mobile Equipment Identity (IMSI). The above terminal device may encrypt the receipt signing scenario information using various encryption methods. The above encryption algorithms may include, but are not limited to: advanced encryption standard (AES) algorithm, an RSA encryption algorithm, an elliptic curve cryptography (ECC) algorithm, a Diffie-Hellman (DH) algorithm, a secure hash algorithm (SHA), or the like.

Alternatively, the above receipt signing scenario information may be encrypted using an asymmetric encryption algorithm, e.g., the elliptic curves cryptography (FCC) algorithm.

In the present embodiment, the encrypted receipt signing scenario information may further include decryption password information. The encryption password, for example, may be related to the international mobile equipment identity, and the decryption password, for example, may be related to the international mobile equipment identity. The encryption password and the decryption password may be different, and each may be a part of the international mobile equipment identity. For example, the encryption password may be first 7 bits of the international mobile equipment identity, and the decryption password may be last 8 bits of the international mobile equipment identity.

Further alternatively, the above method 300 for signing a receipt of an order may further include the following steps:

Step 306: sending a query request to the server. The query request may include the code information of the order.

Here, the terminal device sends a query request for querying an order receipt signing scenario to the above server.

Step 307: receiving a receipt signing QR code corresponding to the receipt signing scenario information of the order and being returned based on the query request.

Here, the terminal device receives a receipt signing QR code corresponding to the code information of the order and being returned by the server based on the query request.

Step 308: scanning and decrypting the receipt signing QR code to obtain the receipt signing scenario information corresponding to the order.

After receiving, the receipt signing QR code sent by the server, the terminal device may scan the receipt signing QR code, decrypt the scanned receipt signing OR code, and then obtain the receipt signing scenario information of the order.

Thus, when the user has a dispute about order delivery, the user may query from the server using the terminal device based on an order code. The server may return a receipt signing QR code corresponding to the encrypted receipt signing scenario information stored in a database connected to the server to the terminal device. The terminal device may scan the receipt signing QR code, and decrypt the encrypted receipt signing scenario information to obtain restored receipt signing scenario information. That is, both encryption operation and decryption password operation may be carried out on the terminal device, thereby avoiding revealing personal information of the receipt signer.

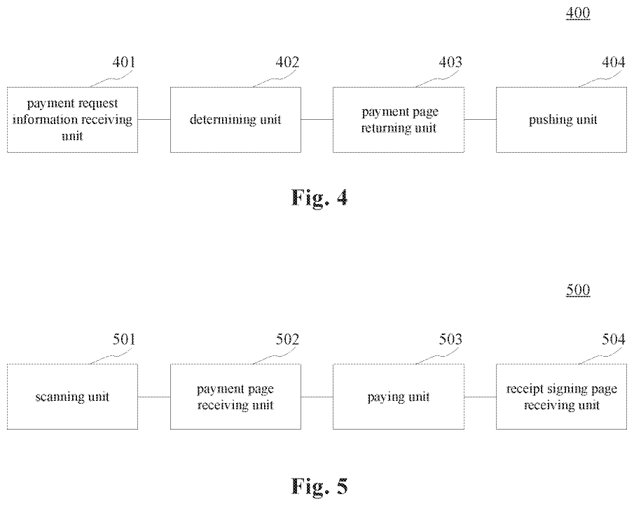

Further referring to FIG. 4, as an implementation of the method shown in the above figures, the present disclosure provides an embodiment of an apparatus for signing a receipt of an order. The embodiment of the apparatus corresponds to the embodiment of the method shown in FIG. 2, and the apparatus may be specifically applied to various electronic devices.

As shown in FIG. 4, the apparatus 400 for signing a receipt of an order in the present embodiment includes: a payment request information receiving unit 401 configured to receive request information sent by a user terminal, the request information including identifier information of the user terminal, order code information corresponding to the order, and payment account information, the request information being generated by the user terminal through scanning a payment QR code corresponding to the order on a delivery terminal; a determining unit 402 configured to determine whether a to-be-paid amount corresponding to the order is greater than zero; a payment page returning unit 403 configured to return, in response to determining that the to-be-paid amount corresponding to the order is greater than zero, a payment page corresponding to the order to the user terminal; and a pushing unit 404 configured to push, in response to receiving information of successfully paying the to-be-paid amount from the user terminal, a customer receipt signing page corresponding to the order to the user terminal.

The related description of step 201, step 202, step 203, and step 204 in the corresponding embodiment of FIG. 2 may be referred to for specific processing of the payment request information receiving unit 401, the determining unit 402, the payment page returning unit 403, and the pushing unit 404 of the apparatus 400 for signing a receipt of an order and the technical effects thereof in the present embodiment, respectively. The description will not be repeated here.

In some alternative implementations of the present embodiment, the pushing, unit 404 may be further configured to push, in response to determining that the to-be-paid amount corresponding to the order is equal to zero, the customer receipt signing page corresponding to the order to the user terminal, such that a receipt signer signs the receipt of the order on the user terminal, thereby avoiding the behavior of substitutive signing by a deliveryman.

In some alternative implementations of the present embodiment, the apparatus for signing a receipt of an order may further include a storing unit 405. The storing unit is configured to receive and store, after the pushing unit 404 pushes the customer receipt signing page corresponding to the order to the user terminal, receipt signing scenario information that is collected, encrypted, and uploaded by the user terminal, where the receipt signing scenario information includes face image information of the receipt signer, geographical location information of the user terminal, and identity information of the user terminal. Encrypted receipt signing scenario information stored in the storing unit may be used as the basis for delivery query in case of a dispute about order delivery, thereby avoiding unnecessary economic losses.

Alternatively, the storing unit is further configured to generate a receipt signing QR code storing the above receipt signing scenario information, and store the receipt signing QR code. The receipt signing QR code generated based on the receipt signing scenario information is stored, thereby avoiding revealing user information.

Further alternatively, the apparatus for signing a receipt of an order may further include a sending unit (not shown in the figure) configured to send, in response to receiving a query request of the user terminal, the receipt signing QR code to the user terminal.

Further referring to FIG. 5, as an implementation of the method shown in the above FIG. 3, the present disclosure provides another embodiment of an apparatus for signing a receipt of an order. The embodiment of the apparatus corresponds to the embodiment of the method shown in FIG. 3, and the apparatus may be specifically applied to various electronic devices.

As shown in FIG. 5, the above apparatus 500 for signing a receipt of an order of the present embodiment includes: a scanning unit 501 configured to scan a payment QR code corresponding to the order on a delivery terminal, the payment QR code including code information of the order and information of a beneficiary account; a payment page receiving unit 502 configured to receive a payment page corresponding to the order being returned based on the scan of the payment QR code and a to-be-paid amount, the to-be-paid amount corresponding to the order and being greater than zero; a paying unit 503 configured to pay, in response to user operation, the to-be-paid amount to the beneficiary account; and a receipt signing page receiving unit 504 configured to receive a customer receipt signing page corresponding to the order and being returned based on a successful payment to the beneficiary account, the customer receipt signing page including code information of the order, signing time information, and an area for signature.

The related description of step 301, step 302, step 303, and step 304 in the corresponding embodiment of FIG. 3 may be referred to for specific processing of the scanning unit 501, the payment page receiving unit 502, the paying unit 503, and the receipt signing page receiving unit 504 of the apparatus 500 for signing a receipt of an order and the technical effects thereof in the present embodiment, respectively. The description will not be repeated here.

In some alternative implementations of the present embodiment, the receipt signing page receiving unit is further configured to receive the customer receipt signing page corresponding to the order and being returned based on the scan of the payment QR code and the to-be-paid amount, the to-be-paid amount corresponding to the order and being equal to zero.

In some alternative implementations of the present embodiment, the apparatus 500 for signing a receipt of an order further includes a collecting unit 505. The collecting unit 505 is configured Lo collect receipt signing scenario information, encrypt the collected receipt signing scenario information, and then upload the encrypted receipt signing scenario information to a server corresponding to the beneficiary account; where the receipt signing scenario information includes face information of a receipt signer, geographical location information of a user terminal, and identity information of the user terminal.

Further alternatively, the apparatus 500 for signing a receipt of an order further includes a querying unit (not shown in the figure), the querying unit being configured to send a query request to the server, the query request including the code information of the order; receive a receipt signing QR code corresponding to the receipt signing scenario information of the order and being returned based on the query request; and scan and decrypt the receipt signing QR code to obtain the receipt signing scenario information corresponding to the order.

The present disclosure further provides an electronic device. The electronic device may include the apparatus for signing a receipt of an order described in FIG. 4. The electronic device may be provided with one or more processors; and a memory configured to store one or more programs, where the one or more programs may contain instructions for executing the operations described in the above steps 201-204. The one more programs, when executed by the one or more processors, cause the one or more processors to execute the operations described in the above steps 201-204.

The present disclosure further provides a terminal device. The terminal device may include the apparatus for signing a receipt of an order described in FIG. 5. The terminal device may be provided with one or more processors; and a memory configured to store one or more programs, where the one or more programs may contain instructions for executing the operations described in the above steps 301-304. The one or more programs, when executed by the one or more processors, cause the one or more processors to execute the operations described in the above steps 301-304.

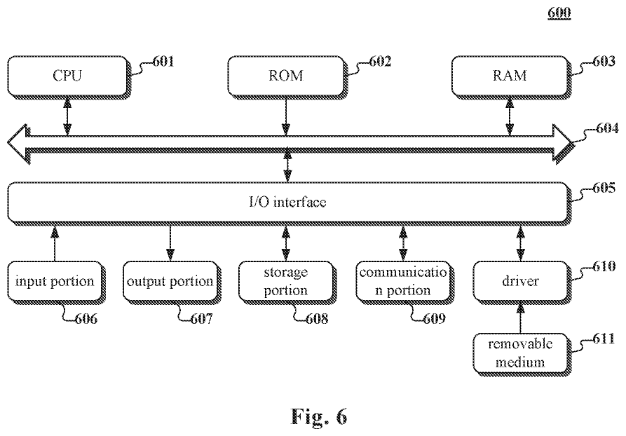

Referring to FIG. 6 below, a schematic structural diagram of a computer system 600 adapted to implement an electronic device and a terminal device of the embodiments of the present disclosure is shown.

As shown in FIG. 6, the computer system 600 includes a central processing unit (CPU) 601, which may execute various appropriate actions and processes in accordance with a program stored in a read only memory (ROM) 602 or a program loaded into a random access memory (RAM) 603 from a storage portion 608. The RAM 603 further stores various programs and data required by operations of the system 600. The CPU 601, the ROM 602, and the RAM 603 are connected to each other through a bus 604. An input/output (I/O) interface 605 is also connected to the bus 604.

The following components are connected to the I/O interface 605: an input portion 606 including a keyboard, a mouse, or the like; an output portion 607 including a liquid crystal display (LCD), a speaker, or the like; a storage portion 608 including a hard disk, or the like; and a communication portion 609 including a network interface card, such as a LAN card and a modem. The communication portion 609 performs communication processing via a network, such as the Internet. A driver 610 is also connected to the I/O interface 605 as required. A removable medium 611, such as a magnetic disk, an optical disk, a magneto-optical disk, and a semiconductor memory, may be installed on the driver 610 as required, such that a computer program read therefrom is installed in the storage portion 608 as needed.

In particular, according to some embodiments of the present disclosure, the process described above with reference to the flow chart may be implemented in a computer software program. For example, some embodiments of the present disclosure include a computer program product, which includes a computer program that is tangibly embedded in a computer readable medium. The computer program includes program codes for executing the method as shown in the flow chart. In such an embodiment, the computer program may be downloaded and installed from a network via the communication portion 609, and/or may be installed from the removable medium 611. The computer program, when executed by the central processing unit (CPU) 601, implements the above functions defined by the method of some embodiments of the present disclosure. It should be noted that the computer readable medium according to the present disclosure may be a computer readable signal medium or a computer readable storage medium or any combination of the above two. An example of the computer readable storage medium may include, but is not limited to: electric, magnetic, optical, electromagnetic, infrared, or semiconductor systems, servers, or elements, or a combination of any of the above. A more specific example of the computer readable storage medium may include, but is not limited to: an electrical connection with one or more pieces of wire, a portable computer disk, a hard disk, a random access memory (RAM), a read only memory (ROM), an erasable programmable read only memory (EPROM or flash memory), an optical fiber, a portable compact disk read only memory (CD-ROM), an optical memory, a magnetic memory, or any suitable combination of the above. In the present disclosure, the computer readable storage medium may be any tangible medium containing or storing programs, which may be used by, or used in combination with, a command execution system, server or element. In some embodiments of the present disclosure, the computer readable signal medium may include a data signal in the base band or propagating as a part of a carrier wave, in which computer readable program codes are carried. The propagating data signal may take various forms, including but not limited to an electromagnetic signal, an optical signal, or any suitable combination of the above. The computer readable signal medium may also be any computer readable medium except for the computer readable storage medium. The computer readable medium is capable of transmitting, propagating or transferring programs for use by, or used in combination with, a command execution system, server or element. The program codes contained on the computer readable medium may be transmitted with any suitable medium, including but not limited to: wireless, wired, optical cable, RF medium, etc., of any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion including one or more executable instructions for implementing specified logical functions. It should be further noted that, in some alternative implementations, the functions denoted by the blocks may also occur in a sequence different from the sequences shown in the figures. For example, any two blocks presented in succession may be executed substantially in parallel, or sometimes be executed in a reverse sequence, depending on the functions involved. It should be further noted that each block in the block diagrams and/or flow charts as well as a combination of blocks in the block diagrams and/or flow charts may be implemented using a dedicated hardware-based system executing specified functions or operations, by a combination of dedicated hardware and computer instructions.

The units involved in some embodiments of the present disclosure may be implemented by software or hardware. The described units may also be provided in a processor, for example, described as: a processor including a payment request information receiving unit, a determining unit, a payment page returning unit, and a pushing unit. The names of the units do not constitute a limitation to such units themselves in some cases. For example, the determining unit may be further described as “a unit configured to determine whether a to-be-paid amount corresponding to the order is greater than zero.”

In another aspect, the present disclosure further provides a computer readable medium. The computer readable medium may be included in the apparatus described in the above embodiments, or a stand-alone computer readable medium without being assembled into the apparatus. The computer readable medium stores one or more programs. The one or more programs, when executed by the apparatus, cause the apparatus to: receive payment request information sent by a user terminal, the payment request information including identifier information of the user terminal, code information corresponding to the order, and payment account information, the payment request information being generated by the user terminal through scanning a payment QR code corresponding to the order on a delivery terminal; determine whether a to-be-paid amount corresponding to the order is greater than zero; return, in response to determining that the to-be-paid amount corresponding to the order is greater than zero, a payment page corresponding to the order to the user terminal; and push, in response to receiving information of successfully paying the to-be-paid amount from the user terminal, a customer receipt signing page corresponding to the order to the user terminal.

In another aspect, the present disclosure further provides another computer readable medium. The computer readable medium may be included in the apparatus described in the above embodiments, or a stand-alone computer readable medium without being assembled into the apparatus. The computer readable medium stores one or more programs. The one or more programs, when executed by the apparatus, cause the apparatus to: scan a payment QR code corresponding to a to-be-paid order on a delivery terminal, the payment QR code including code information of the order and information of a beneficiary account; receive a payment page corresponding to the order and being returned based on the scan of the QR code and a to-be-paid amount, the to-be-paid amount corresponding to the order and being greater than zero; pay, in response to a user operation, the to-be-paid amount to the beneficiary account; and receive a customer receipt signing page corresponding to the order and being returned based on a successful payment to the beneficiary account, the customer receipt signing page including code information of the order, signing time information, and an area for signature.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present disclosure are examples.

1. A method for signing a receipt of an order, comprising:
receiving payment request information sent by a user terminal, the payment request information comprising identifier information of the user terminal, code information corresponding to the order, and payment account information, the payment request information being generated by the user terminal through scanning a payment QR code corresponding to the order on a delivery terminal;
determining whether a to-be-paid amount corresponding to the order is greater than zero;
returning, in response to determining that the to-be-paid amount corresponding to the order is greater than zero, a payment page corresponding to the order to the user terminal; and
pushing, in response to receiving information of a successful payment of the to-be-paid amount from the user terminal, a customer receipt signing page corresponding to the order to the user terminal.

2. The method according to claim 1, wherein the method further comprises:
pushing, in response to determining that the to-be-paid amount corresponding to the order is equal to zero, the customer receipt signing page corresponding to the order to the user terminal.

3. The method according to claim 1, wherein after the pushing a customer receipt signing page corresponding to the order to the user terminal, the method further comprises:
receiving and storing receipt signing scenario information, the receipt signing scenario information being uploaded by the user terminal after being collected and encrypted by the user terminal, wherein the receipt signing scenario information comprises face image information of a receipt signer, geographical location information of the user terminal, and identity information of the user terminal.

4. The method according to claim 3, wherein the receiving and storing receipt signing scenario information, the receipt signing scenario information being uploaded by the user terminal after being collected and encrypted by the user terminal, comprises:
generating and storing a receipt signing QR code corresponding to the receipt signing scenario information.

5. The method according to claim 4, wherein the method further comprises:
sending, in response to receiving a query request of the user terminal, the receipt signing QR code to the user terminal.

6. A method for signing a receipt of an order, comprising:
scanning a payment QR code corresponding to a to-be-signed order on a delivery terminal, the payment QR code comprising code information of the order and information of a beneficiary account;
receiving a payment page corresponding to the order and being returned based on a scan of the payment QR code and a to-be-paid amount, the to-be-paid amount corresponding to the order and being greater than zero;
paying, in response to a user operation, the to-be-paid amount to the beneficiary account; and
receiving a customer receipt signing page corresponding to the order and being returned based on a successful payment to the beneficiary account, the customer receipt signing page comprising code information of the order, receipt signing time information, and an area for signature.

7. The method according to claim 6, wherein the method further comprises:
receiving the customer receipt signing page corresponding to the order and being returned based on the scan of the payment QR code and the to-be-paid amount, to-be-paid amount corresponding to the order and being equal to zero.

8. The method according to claim 6, wherein after the receiving a customer receipt signing page corresponding to the order and being returned based on a successful payment to the beneficiary account, the method further comprises:
collecting receipt signing scenario information, encrypting the collected receipt signing scenario information, and uploading the encrypted receipt signing scenario information to a server corresponding to the beneficiary account, such that the server generates a receipt signing QR code;
wherein the receipt signing scenario information comprises face information of a receipt signer, geographical location information of a user terminal, and identity information of the user terminal.

9. The method according to claim 8, wherein after the encrypting the collected receipt signing scenario information, and uploading the encrypted receipt signing scenario information to a server corresponding to the beneficiary account, the method further comprises:
sending a query request to the server, the query request comprising the code information of the order;
receiving a receipt signing QR code corresponding to the receipt signing scenario information of the order and being returned based on the query request; and
scanning and decrypting the receipt signing QR code to obtain the receipt signing scenario information corresponding to the order.

10. An apparatus for signing a receipt of an order, comprising:
at least one processor; and
a memory storing instructions, wherein the instructions when executed by the at least one processor, cause the at least one processor to perform operations, the operations comprising:
receiving request information sent by a user terminal, the request information comprising identifier information of the user terminal, order code information corresponding to the order, and payment account information, the request information being generated by the user terminal through scanning a payment QR code corresponding to the order on a delivery terminal;
determining whether a to-be-paid amount corresponding to the order is greater than zero;
returning, in response to determining that the to-be-paid amount corresponding to the order is greater than zero, a payment page corresponding to the order to the user terminal; and
pushing, in response to receiving information of a successful payment of the to-be-paid amount from the user terminal, a customer receipt signing page corresponding to the order to the user terminal.

11. The apparatus according to claim 10, wherein the operations further comprise pushing, in response to determining that the to-be- paid amount corresponding to the order is equal to zero, the customer receipt signing page corresponding to the order to the user terminal.

12. The apparatus according to claim 10, wherein after the pushing unit pushes a customer receipt signing page corresponding to the order to the user terminal, the operations further comprise:
receiving and storing receipt signing scenario information, the receipt signing scenario information being uploaded by the user terminal after being collected and encrypted by the user terminal, wherein the receipt signing scenario information comprises face image information of a receipt signer, geographical location information of the user terminal, and identity information of the user terminal.

13. The apparatus according to claim 12, wherein the receiving and storing receipt signing scenario information, the receipt signing scenario information being uploaded by the user terminal after being collected and encrypted by the user terminal, comprises:
generating and storing a receipt signing QR code corresponding to the receipt signing scenario information.

14. The apparatus according to claim 13, wherein the operations further comprise sending, in response to receiving a query request of the user terminal, the receipt signing QR code to the user terminal.

15. An apparatus for signing a receipt of an order, comprising at least one processor; and a memory storing instructions, wherein the instructions when executed by the at least one processor, cause the at least one processor to perform operations, the operations comprising the method according to claim 6.

16. The apparatus according to claim 15, wherein the operations further comprise receiving the customer receipt signing page corresponding to the order and being returned based on the scan of the payment QR code and the to-be-paid amount, the-to-be-paid amount corresponding to the order and being equal to zero.

17. The apparatus according to claim 15, wherein the operations further comprise:
collecting receipt signing scenario information, encrypting the collected receipt signing scenario information, and uploading the encrypted receipt signing scenario information to a server corresponding to the beneficiary account, such that the server generates a receipt signing QR code; wherein the receipt signing scenario information comprises face information of a receipt signer, geographical location information of a user terminal, and identity information of the user terminal.

18. The apparatus according to claim 17, wherein the operations further comprise:
sending a query request to the server, the query request comprising the code information of the order;
receiving a receipt signing QR code corresponding to the receipt signing scenario information of the order and being returned based on the query request; and
scanning and decrypting the receipt signing QR code to obtain the receipt signing scenario information corresponding to the order.

19. (canceled)

20. A non-transitory computer readable storage medium, storing a computer program thereon, wherein the program, when executed by a processor, implements the method according to claim 1.

21. (canceled)

22. A non-transitory computer readable storage medium, storing a computer program thereon, wherein the program implements, when executed by a processor, the method according to claim 6.
